(19) United States
(12) Patent Application Publication
(10) Pub. No.: US 2023/0326359 A1
(43) Pub. Date: Oct. 12, 2023

(54) PROGRAMMATIC APPROACH TO CONTENT CREATION TO SUPPORT DISABILITY AND INCLUSION

(71) Applicant: VMware, Inc., Palo Alto, CA (US)

(72) Inventors: Baldeep BIRDY, Northamptonshire (GB); Abhijeet BANERJEE, Bangalore (IN)

(73) Assignee: VMware, Inc., Palo Alto, CA (US)

(21) Appl. No.: 17/717,685

(22) Filed: Apr. 11, 2022

(51) Int. Cl. G09B 5/06; G06F 16/483; G10L 15/26; G06T 19/00

(52) U.S. Cl. CPC G09B 5/065; G06F 16/483; G10L 15/26; G06T 19/006

(57) ABSTRACT

A system to automatically generate an extended reality (XR) presentation from a presentation comprising: a presentation, where the presentation has a speaker notes system, directions for the creation of the XR presentation where the directions are written in the speaker notes system, a script fit to read the directions and generate a metadata file, and a program to read the metadata file and construct the XR presentation.

### BACKGROUND ART

eLearning may take the form of augmented reality (AR), virtual reality (VR), or mixed reality (MR). Extended reality (XR) is a term that covers all of these variants. Current eLearning solutions may involve utilizing VR and text to speech engines, however the process is manual and slow.

Traditional eLearning modules are made by having a live person stand in front of a camera to present the material, and any extra features such as placement of material, animations, or links to future learning are added in post-production. The more recorded material there is, the more likely it is that mistakes may be made in post-production, such as forgetting to insert a link or diagram. Resolving such issues would then take additional time and cost.

### BRIEF DESCRIPTION OF THE DRAWINGS

The accompanying drawings, which are incorporated in and form a part of this specification, illustrate embodiments of the present technology and, together with the description, serve to explain the principles of the present technology.

FIG. 1 is a top-down view of an example 360 learning environment.

FIG. 2 is an example of how the metadata file might read the powerpoint tag data to place information on various points of information such as the primary screen or secondary screens.

### DETAILED DESCRIPTION OF THE EMBODIMENTS

The detailed description set forth below in connection with the appended drawings is intended as a description of various embodiments of the present invention and is not intended to represent the only embodiments in which the present invention is to be practiced. Each embodiment described in this disclosure is provided merely as an example or illustration of the present invention, and should not necessarily be construed as preferred or advantageous over other embodiments. In some instances, well known methods, procedures, and objects have not been described in detail as not to unnecessarily obscure aspects of the present disclosure.

Current options for developing eLearning experiences involve the author manually assembling the environment, layout, timing of aspects like visuals and audio, sign language and translation, subtitles, etc.

The current invention works to use a programmatic approach to content creation allows us to utilize advancements in AI+ML to deliver these needs. The core elements of the solution utilizes scripts and metadata to deliver these elements, based on a powerpoint created by a content author. The metadata provides key data points to define when additional screens should be utilized within a scene, i.e. to deliver multiple points of information, and is accompanied with an automated sign-language translation and markup language to deliver automated sign-language capabilities.

Automating the process of turning a powerpoint into an eLearning experience (such as VR) is a key advantage the present invention holds over current technologies. The present invention operates by using an approach to embed metadata information into an existing powerpoint in order to drive a web based experience to automate the creation of traditional eLearning content.

Any web based approach to enable AR, VR, MR, or combinations thereof (to what is now referred to as XR), may be utilized with the present invention (i.e. Amazon Sumerian, Babalon.js, etc.). While VR will be the primary example used, it should be understood that embodiments utilizing AR, MR, and XR are within the scope or the current invention. The present invention may also use any suitable text to speech system, language translation systems, and the like.

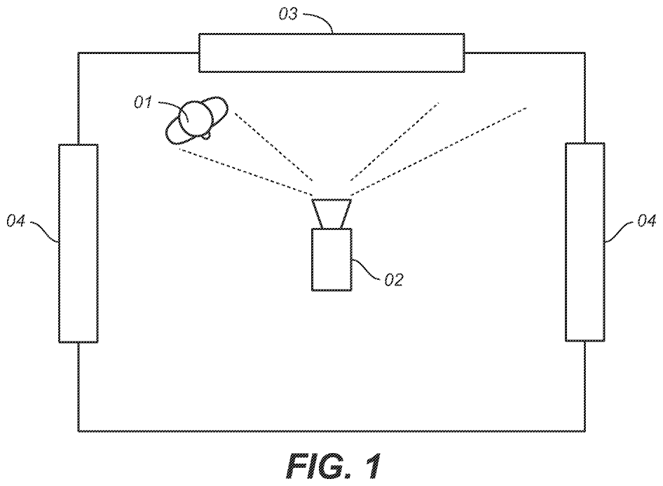

FIG. 1 shows an example of a 360 space for an eLearning experience. When using a 360 space for an eLearning experience, it is typical to see the tutor or virtual trainer 01 in front of the user viewpoint 02. Information may be displayed to the user viewpoint 02 from a point of information 03, 04. While a single primary point of information 03 is sometimes enough, the present invention may make use of multiple points of information such as secondary screens 04 to the left and right of the user. These multiple points of information 03, 04 are one benefit to eLearning experiences, as the primary information can be augmented with the secondary examples to further better understanding on the users end.

While FIG. 1 shows the points of information 03, 04 as being one on each side of the user viewpoint 02, it should be understood that fewer or more points of information may be included in various positions.

Current standard VR delivery lacks a programmatic way to set up such multiple points of information, as the points have to be manually built by the author, along with what content they display and when. The present invention acts as an agnostic way to automatically build this system. The present invention acts to take a powerpoint and generate a video, or XR based eLearning experience from the powerpoint made by a human author.

In order to automatically build an eLearning presentation, the author will first create the presentation and its visuals in a powerpoint format. When making the powerpoint, the author will need to include tags to define what content is presented and how. When the author is ready to export the presentation to an eLearning format, a script will automatically read through the tags to generate a metadata file, which is used by the web/front end to create the eLearning presentation. This includes at least placing visuals on their tag designated point of information 03, using a text to speech engine to narrate, and may even include interactive elements such as a quiz.

One advantage of the current invention is that it allows the author to operate under a paradigm with which they are entirely familiar (i.e. creating a powerpoint). Tags are written by the author and included in the speakers notes section of the UI. Tags are simple and act as commands for the script to read and execute. For example:
<slideSettings fileExtension=“.gif” display=“presentation”>
   may be the tag used to assign the slide and/or animation to appear on the primary point of information that the user will be viewing. Similarly,
<slideSettings fileExtension=“.gif” display=“whiteboard”>
   may be used to assign a slide and/or animation to a secondary point of information.

Tags may also be used to define aspects such as: what the text to speech engine is dictating and when, when an animation should play and for how long, when elements should be interactive (such as a link to further learning, quizzes, gamification elements), security authentication, etc. It should be understood that this list is not limiting but consists of a few examples for clarity and brevity.

As stated, tags can be used to generate interactive elements such as quizzes. This may entail multiple choice, multiple select, or other variants that the author wishes to include. In one example, should the user answer a quiz question wrong the author may include tags that prompt audio feedback from the virtual teacher (via text to speech) recommending to review a specific section.

Another example of tag use includes user authentication. For aspects such as this, there may be multiple tag options an author can pick from that offer varying levels of control on the authors part, or require varying levels of user action.

In one embodiment, if the author has decided to change aspects of the generated eLearning module, they may do so by editing either the powerpoint tags to generate a new metadata file, or they may directly alter the metadata file. For example, the author may dynamically turn on/off user authentication, or change the level of authentication required.

In one embodiment, a metadata file is always created automatically with a minimum of one variable. This variable may be the number of slides, as the script will assume at least that the powerpoint will be presented.

In one embodiment, the author has no part in creating the metadata file. The metadata file is automatically created by the script in the background.

In one embodiment, after the author alters the powerpoint or metadata, the eLearning module will be automatically updated in real time.

In one embodiment, the present invention will also act to automatically translate the script into other languages as required. This may include audio, subtitles, or visuals such as ASL.

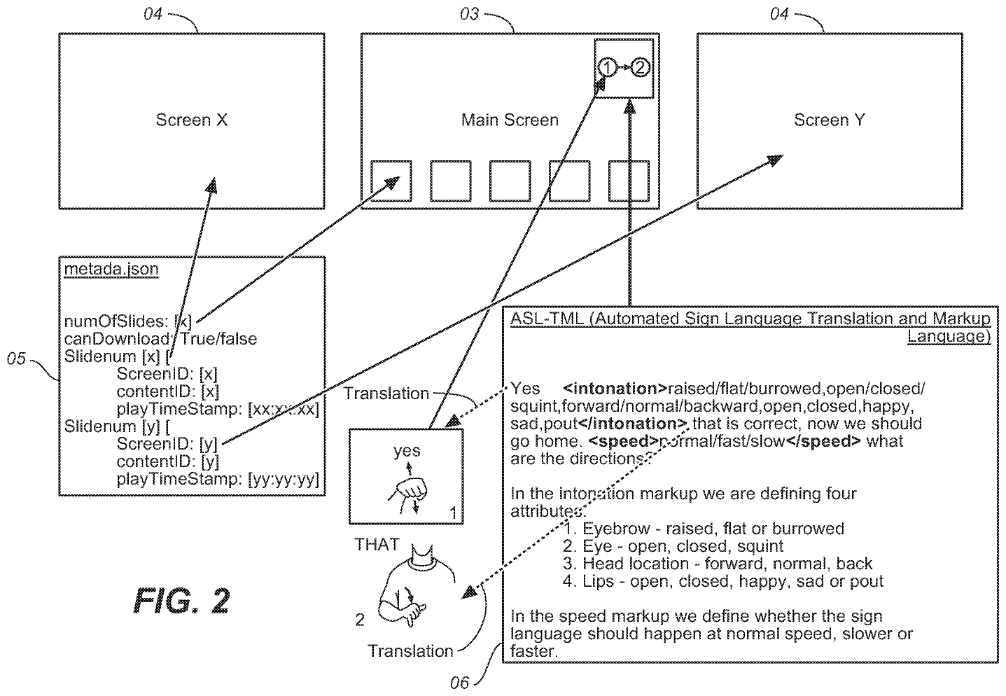

FIG. 2 is an example of how the metadata file might read the powerpoint tag data 05 to place information on various points of information such as the primary screen 03 or secondary screens 04. FIG. 2 also shows the text to ASL process, along with the results placement (in this case on the main screen 03).

The present invention works by utilizing AWS services (however similar services may also apply) to complete the following:

First, a content creator or author uploads a powerpoint to AWS Storage Services.

Then, there is a serverless function that listens for AWS Storage uploads, and is triggered to extract the powerpoint into at least images and speaker notes.

The same script then applies a VMware centric dictionary and vocabulary to allow the AWS text to speech engine to correctly interpret VMware terminology. The script then pipes the result to the AWS Translation services to translate the English speaker notes into the respective languages.

The ASL-TML (Text Markup Language) is then utilized to take the English variant of the speaker notes, and translate this into the various sign-languages the system supports. Each language utilizes different intonation markups, as well as signs, which can be supported by the solution. The result of the sign-language translation is mapped to various media elements (e.g. images, videos, animations), which when combined formulate the sentence structure. These will be delivered as part of a virtual host, with the relevant markups defining how the host will perform the sign-language and intonation elements.

The final component created is an initial metadata file, in a JSON structure. The author can then edit this to include the relevant additional items, see ASL-TML.vsdx, to programmatically define use of multiple points of information. So if they want to present a whiteboard, video or other, during the presentation, they can define when it's presented.

Upon completion of all the steps, a notification is sent to the content creator and the powerpoint is ready to be presented by a virtual trainer to a user.

While the above steps include aspects such as comparing the text within the speaker notes to a VMware centric dictionary, other dictionaries may be used concurrently or as an alternative.

One advantage of the MR eLearning format is that the end user has more control over the learning experience when compared to traditionally filmed lesions, for example being able to jump between specific slides or modules, or being able to rewind of fast forward the lesion. The virtual tutor may be a deep fake, a 3D model, or similar applicable representations.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments can be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What we claim is:

1. A system to automatically generate an extended reality (XR) presentation from a presentation comprising:
a presentation, wherein said presentation has a speaker notes system;
directions for the creation of said XR presentation, said directions written in said speaker notes system;
a script fit to read said directions and generate a metadata file;
a program to read said metadata file and construct said XR presentation.

2. The system to automatically generate a XR presentation from a presentation of claim 1 wherein, said program is web based.

3. The system to automatically generate a XR presentation from a presentation of claim 1 wherein, said script is always generated with at least one variable.

4. The system to automatically generate a XR presentation from a presentation of claim 1 wherein, said XR presentation includes multiple points of information.

5. The system to automatically generate a XR presentation from a presentation of claim 1 wherein, said program utilizes a text to speech engine to dictate information during said XR presentation.

6. The system to automatically generate a XR presentation from a presentation of claim 1 wherein, said metadata file can be directly edited.

7. The system to automatically generate a XR presentation from a presentation of claim 6 wherein, said program automatically updates said XR presentation after said metadata file has been edited.

8. The system to automatically generate a XR presentation from a presentation of claim 1 wherein, said program automatically updates said XR presentation after said presentation has been edited.

9. The system to automatically generate a XR presentation from a presentation of claim 1 wherein, said directions affect aspects of said presentation selected from the group consisting of: when events occur, what information is displayed, placement of information, language dictation, language translation, and if elements are interactive.

10. A system to automatically generate an extended reality (XR) presentation from a presentation comprising:
a presentation, wherein said presentation has a speaker notes system;
directions for the creation of said XR presentation, said directions written in said speaker notes system;
a script fit to read said directions and generate a metadata file, wherein said script is automatically generated with at least one variable;
a web based program to read said metadata file and construct said XR presentation.

11. The system to automatically generate a XR presentation from a presentation of claim 10 wherein, said XR presentation includes multiple points of information.

12. The system to automatically generate a XR presentation from a presentation of claim 10 wherein, said program utilizes a text to speech engine to dictate information during said XR presentation.

13. The system to automatically generate a XR presentation from a presentation of claim 10 wherein, said metadata file can be directly edited.

14. The system to automatically generate a XR presentation from a presentation of claim 13 wherein, said program automatically updates said XR presentation after said metadata file has been edited.

15. The system to automatically generate a XR presentation from a presentation of claim 10 wherein, said program automatically updates said XR presentation after said presentation has been edited.

16. The system to automatically generate a XR presentation from a presentation of claim 10 wherein, said directions affect aspects of said presentation selected from the group consisting of: when events occur, what information is displayed, placement of information, language dictation, language translation, and if elements are interactive.

17. A system to automatically generate an extended reality (XR) presentation from a presentation comprising:
a presentation, wherein said presentation has a speaker notes system;
directions for the creation of said XR presentation, said directions written in said speaker notes system;
a script fit to read said directions and generate a metadata file, wherein said scrip is automatically generated with at least one variable;
a web based program to read said metadata file and construct said XR presentation, wherein said web based program automatically updates when said presentation or said metadata file is edited.

18. The system to automatically generate a XR presentation from a presentation of claim 17 wherein, said program utilizes a text to speech engine to dictate information during said XR presentation.

19. The system to automatically generate a XR presentation from a presentation of claim 17 wherein, said metadata file can be directly edited.

20. The system to automatically generate a XR presentation from a presentation of claim 17 wherein, said directions affect aspects of said presentation selected from the group consisting of: when events occur, what information is displayed, placement of information, language dictation, language translation, and if elements are interactive.
